(19) United States
(12) Patent Application Publication
(10) Pub. No.: US 2011/0221924 A1
(43) Pub. Date: Sep. 15, 2011

(54) IMAGE SENSING DEVICE

(75) Inventor: Toshitaka KUMA, Osaka City (JP)

(73) Assignee: SANYO ELECTRIC CO., LTD., Moriguchi City (JP)

(21) Appl. No.: 13/046,298

(22) Filed: Mar. 11, 2011

(30) Foreign Application Priority Data
Mar. 12, 2010 (JP) 2010-055254

(51) Int. Cl. H04N 5/228

(52) U.S. Cl. 348/222.1; 348/E05.031

(57) ABSTRACT

An image sensing device includes: a display portion that displays a shooting image; a scene determination portion that determines a shooting scene of the shooting image based on image data on the shooting image; and a display control portion that displays, on the display portion, the result of determination by the scene determination portion and a position of a specific image region which is a part of an entire image region of the shooting image and on which the result of the determination by the scene determination portion is based.

This nonprovisional application claims priority under 35 U.S.C. §119(a) on Patent Application No. 2010-055254 filed in Japan on Mar. 12, 2010, the entire contents of which are hereby incorporated by reference.

### BACKGROUND OF THE INVENTION

1. Field of the Invention

The present invention relates to an image sensing device such as a digital still camera or a digital video camera.

2. Description of Related Art

When shooting is performed with an image sensing device such as a digital camera, at a specific shooting scene, there are optimum shooting conditions (such as a shutter speed, an aperture value and an ISO sensitivity) corresponding to the shooting scene. However, in general, it is complicated to manually set shooting conditions. In view of the foregoing, an image sensing device often has an automatic scene determination function of automatically determining a shooting scene and automatically optimizing shooting conditions. In this function, a shooting scene is determined such as by identifying the type of subject present within a shooting range or detecting the brightness of the subject, and the optimum shooting mode is selected from a plurality of registered shooting modes based on a determination scene. Then, shooting is performed under shooting conditions corresponding to the selected shooting mode, and thus the shooting conditions are optimized.

In a conventional method, based on the extraction of the amount of feature and the result of face detection, a plurality of candidates of shooting modes (image sensing modes) that can be actually employed are extracted from a shooting mode storage portion, and the candidates are displayed, and a user selects, from the displayed candidates, the shooting mode that is actually employed.

However, in the automatic scene determination described above, it is possible that the automatically determined scene and the correspondingly automatically selected shooting mode differ from those intended by the user. In this case, the user needs to repeat the automatic scene determination until the desired result of the scene determination is obtained, with the result that the convenience of the user is likely to be reduced.

This problem will be further described with reference to FIG. 16. It is assumed that trees with yellow leaves located substantially in front of an image sensing device and trees with red leaves located on the right side of the image sensing device are kept in a shooting range, and that the user desires to shoot a still image in a leaf coloration mode. It is also assumed that a shutter button provided on the image sensing device is pressed halfway and thus an automatic scene determination is performed, and that, after the operation of pressing it halfway is cancelled, the shutter button is pressed halfway again and thus the automatic scene determination is performed again.

The user first puts the two types of trees into the shooting range. Thus, an image 901 is displayed on a display screen. A dotted region (region filled with dots) surrounding the image 901 indicates the housing of a display portion (the same is true in images 902 to 904). In this state, the user presses the shutter button halfway. When, as a result of the automatic scene determination triggered by the operation of pressing it halfway, the shooting scene is determined to be a scenery scene, the image 902 on which a word “scenery” is superimposed is displayed. Since the user does not desire to shoot in the scenery mode, the user repeatedly cancels and performs the operation of pressing the shutter button halfway while changing the direction of shooting and the angle of view of shooting. The image 903 is an image that is displayed after the second operation of pressing the shutter button halfway, and the image 904 is an image that is displayed after the third operation of pressing the shutter button halfway. Since, after the third operation of pressing the shutter button halfway (that is, after the third automatic scene determination), the shooting scene is determined to be the leaf coloration scene, the user then performs an operation of fully pressing the shutter button to shoot a still image.

In the specific example of FIG. 16, when the image 902 is displayed, the user does not understand why the shooting scene is determined to be the scenery scene. Hence, the user is thereafter forced to repeatedly perform and cancel the operation of pressing the shutter button halfway on a trial and error basis without any clue until the shooting scene is determined to be the leaf coloration scene. Although it is difficult to prevent the determination scene (scenery scene) resulting from the automatic scene determination and the scene (leaf coloration scene) desired by the user from differing from each other, the user has an uncomfortable feeling because the scene different from that desired by the user is determined and moreover the user does not fully understand why such a determination is made. In terms of a technology for providing a comfortable feeling at the time of operation, it is therefore useful to indicate grounds and the like for the automatic scene determination.

When the method is used of displaying candidates of shooting modes that can be actually employed and making the user to select, from the displayed candidates, the shooting mode that is actually employed, it is possible to narrow down a large number of candidates to some extent, but the user is forced to perform an operation of selecting one candidate from the narrowed-down candidates. Especially when there are a large number of candidates, it is bothersome to perform the selection operation, and consequently, the user is confused about the selection and therefore has an uncomfortable feeling. In particular, in a complicated shooting scene where various subjects are present within the shooting range, since a subject targeted by the user is unclear to an image sensing device, it is highly likely that the displayed candidates of shooting modes do not include the shooting mode desired by the user.

### SUMMARY OF THE INVENTION

An image sensing device according to the present invention includes: a display portion that displays a shooting image; a scene determination portion that determines a shooting scene of the shooting image based on image data on the shooting image; and a display control portion that displays, on the display portion, the result of determination by the scene determination portion and a position of a specific image region which is a part of an entire image region of the shooting image and on which the result of the determination by the scene determination portion is based.

The significance and effects of the present invention will be further made clear from the description of embodiments below. However, the following embodiments are simply some of embodiments according to the present invention, and the present invention and the significance of the term of each of components are not limited to the following embodiments.

### BRIEF DESCRIPTION OF THE DRAWINGS

FIG. 1 is an entire block diagram schematically showing an image sensing device according to an embodiment of the present invention;

FIG. 2 is a diagram showing the internal configuration of an image sensing portion shown in FIG. 1;

FIG. 3 is a block diagram of a portion included in the image sensing device of FIG. 1;

FIG. 4 is a diagram showing how a determination region is set in an input image;

FIGS. 5A and 5B show an output image obtained in a scenery mode and an output image obtained in a portrait mode, respectively;

FIG. 6 is a flowchart showing the operation procedure of the image sensing device according to a first embodiment of the present invention;

FIG. 7 is a diagram showing a first specific example of how a display image is changed in the first embodiment of the present invention;

FIG. 8 is a diagram showing a second specific example of how a display image is changed in the first embodiment of the present invention;

FIG. 9 is a diagram showing how a plurality of division blocks are set on an arbitrary two-dimensional image or display screen;

FIG. 10 is a flowchart showing the operation procedure of an image sensing device according to a second embodiment of the present invention;

FIG. 11 is a diagram showing a specific example of how a display image is changed in the second embodiment of the present invention;

FIG. 12 is a diagram showing how a registration memory is included in a scene determination portion;

FIG. 13 is a diagram showing how a plurality of target block frames are displayed in the second embodiment of the present invention;

FIG. 14 is a variation of a flow chart showing the operation procedure of the image sensing device according to the second embodiment of the present invention;

FIG. 15 is a diagram showing the internal blocks of a scene determination portion according to the second embodiment of the present invention; and

FIG. 16 is a diagram illustrating the operation of a conventional automatic scene determination.

### DETAILED DESCRIPTION OF PREFERRED EMBODIMENTS

Some embodiments of the present invention will be specifically described below with reference to the accompanying drawings. In the referenced drawings, like parts are identified with like symbols, and their description will not be repeated in principle.

### First Embodiment

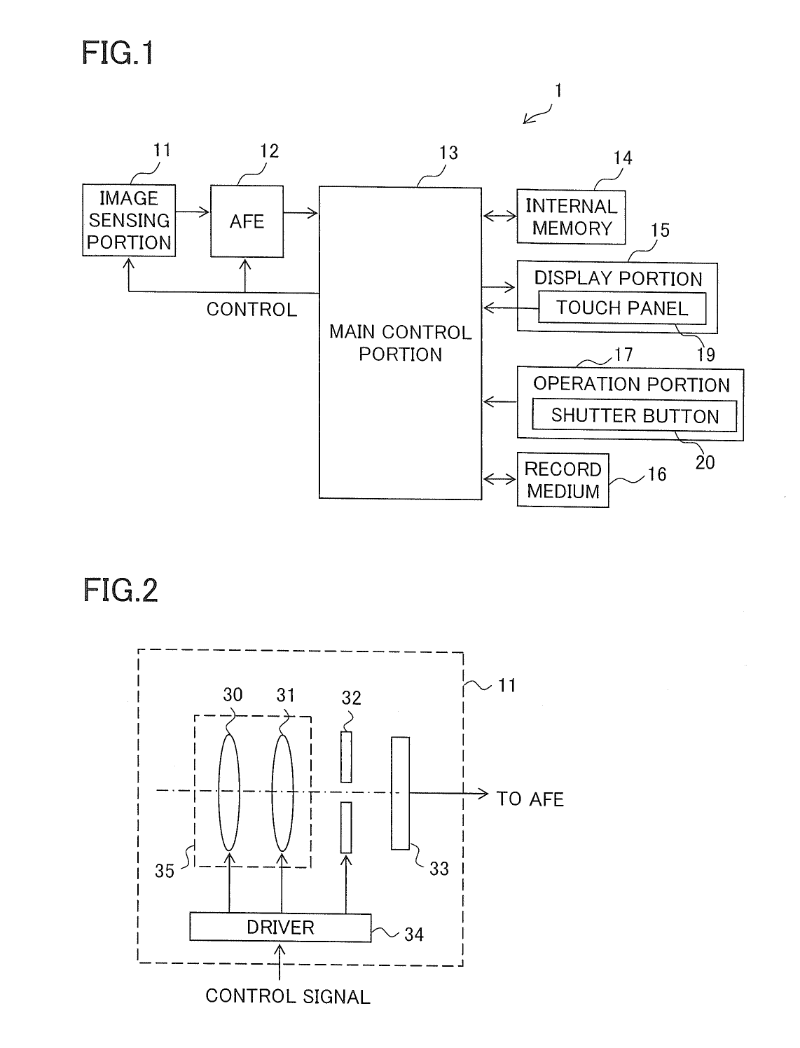

A first embodiment of the present invention will be described. FIG. 1 is an entire block diagram schematically showing an image sensing device 1 of the first embodiment. The image sensing device 1 is either a digital still camera that can shoot and record a still image or a digital video camera that can shoot and record a still image and a moving image. The image sensing device 1 may be incorporated in a portable terminal such as a mobile telephone.

The image sensing device 1 includes an image sensing portion 11, an AFE (analog front end) 12, a main control portion 13, an internal memory 14, a display portion 15, a record medium 16 and an operation portion 17.

In FIG. 2, a diagram showing the internal configuration of the image sensing portion 11 is shown. The image sensing portion 11 includes an optical system 35, an aperture 32, an image sensor 33 formed with a CCD (charge coupled device), a CMOS (complementary metal oxide semiconductor) image sensor or the like and a driver 34 that drives and controls the optical system 35 and the aperture 32. The optical system 35 is formed with a plurality of lenses including a zoom lens 30 and a focus lens 31. The zoom lens 30 and the focus lens 31 can move in the direction of an optical axis. The driver 34 drives and controls, based on a control signal from the main control portion 13, the positions of the zoom lens 30 and the focus lens 31 and the degree of opening of the aperture 32, and thereby controls the focal length (angle of view) and the focus position of the image sensing portion 11 and the amount of light entering the image sensor 33 (that is, an aperture value).

The image sensor 33 photoelectrically converts an optical image that enters the image sensor 33 through the optical system 35 and the aperture 32 and that represents a subject, and outputs to the AFE 12 an electrical signal obtained by the photoelectrical conversion. Specifically, the image sensor 33 has a plurality of light receiving pixels that are two-dimensionally arranged in a matrix, and each of the light receiving pixels stores, in each round of shooting, a signal charge having the amount of charge corresponding to an exposure time. Analog signals having a size proportional to the amount of stored signal charge are sequentially output to the AFE 12 from the light receiving pixels according to drive pulses generated within the image sensing device 1.

The AFE 12 amplifies the analog signal output from the image sensing portion 11 (image sensor 33), and converts the amplified analog signal into a digital signal. The AFE 12 outputs this digital signal as RAW data to the main control portion 13. The amplification factor of the signal in the AFE 12 is controlled by the main control portion 13.

The main control portion 13 is composed of a CPU (central processing unit), a ROM (read only memory), a RAM (random access memory) and the like. The main control portion 13 generates, based on the RAW data from the AFE 12, image data representing an image (hereinafter also referred to as a shooting image) shot by the image sensing portion 11. The image data generated here includes, for example, a brightness signal and a color-difference signal. The RAW data itself is one type of image data; the analog signal output from the image sensing portion 11 is also one type of image data. The main control portion 13 also functions as display control means for controlling the details of a display on the display portion 15, and performs control necessary for display on the display portion 15.

The internal memory 14 is formed with an SDRAM (synchronous dynamic random access memory) or the like, and temporarily stores various types of data generated within the image sensing device 1. The display portion 15 is a display device that has a display screen such as a liquid crystal display panel, and displays, under control by the main control portion 13, a shot image, an image recorded in the record medium 16 or the like.

The display portion 15 is provided with a touch panel 19, and the user can give a specific instruction to the image sensing device 1 by touching the display screen of the display portion 15 by a finger or the like. An operation that is performed by touching the display screen of the display portion 15 by a finger or the like is referred to as a touch panel operation. In the present specification, a display and a display screen simply refer to a display on the display portion 15 and the display screen of the display portion 15, respectively. When a finger or the like touches the display screen of the display portion 15, a coordinate value indicating the touched position is transmitted to the main control portion 13.

The record medium 16 is a nonvolatile memory such as a card semiconductor memory or a magnetic disk, and stores a shooting image and the like under control by the main control portion 13. The operation portion 17 has a shutter button 20 or the like through which an instruction to shoot a still image is received, and receives various operations from the outside. An operation performed on the operation portion 17 is also referred to as a button operation so that the button operation is distinguished from the touch panel operation. The details of the operation performed on the operation portion 17 are transmitted to the main control portion 13.

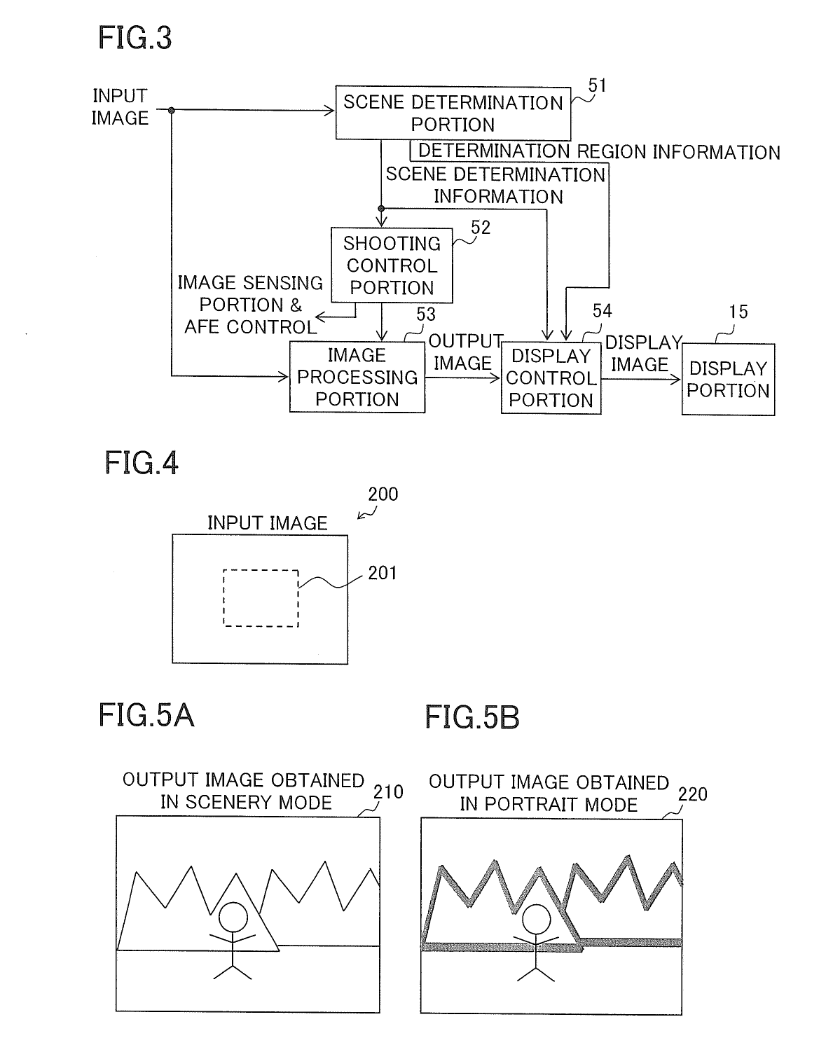

The image sensing device 1 has the function of automatically determining a scene that is intended to be shot by the user and automatically optimizing shooting conditions. This function will be mainly described below. FIG. 3 is a block diagram of a portion that is particularly involved in achieving this function. A scene determination portion 51, a shooting control portion 52, an image processing portion 53 and a display control portion 54 are provided within the main control portion 13 of FIG. 1.

Image data on an input image is fed to the scene determination portion 51. The input image refers to a two-dimensional image based on image data output from the image sensing portion 11. The RAW data itself may be the image data on the input image, or image data obtained by subjecting the RAW data to predetermined image processing (such as demosaicing processing, noise reduction processing or color correction processing) may be the image data on the input image. Since the image sensing portion 11 can shoot at a predetermined frame rate, the input images are also sequentially obtained at the predetermined frame rate.

The scene determination portion 51 sets a determination region within the input image, and performs scene determination processing based on image data within the determination region. The scene determination portion 51 can perform the scene determination processing on each of the input images.

FIG. 4 shows a relationship between the input image and the determination region. In FIG. 4, reference numeral 200 represents an arbitrary sheet of an input image, and reference numeral 201 represents a determination region set in the input image 200. The determination region 201 is either the entire image region itself of the input image 200 or a part of the entire image region of the input image 200. In FIG. 4, the determination region 201 is assumed to be a part of the entire image region of the input image 200. In the following description, as shown in FIG. 4, an arbitrary determination region of which the determination region 201 is typical is assumed to be rectangular in shape. As the shape of the determination region 201, a shape other than a rectangle can be used.

The scene determination processing on the input image is performed using the extraction of the amount of image feature from the input image, the detection of a subject of the input image, the analysis of a hue of the input image, the estimation of the state of a light source of the subject at the time of shooting of the input image and the like. Such a determination can be performed by a known method (for example, a method disclosed in JP-A-2009-71666).

A plurality of registration scenes are previously set in the scene determination portion 51. For example, the registration scenes can include: a portrait scene that is a shooting scene where a person is targeted; a scenery scene that is a shooting scene where scenery is targeted; a leaf coloration scene that is a shooting scene where leaf coloration is targeted; an animal scene that is a shooting scene where an animal is targeted; a sea scene that is a shooting scene where a sea is targeted; a daytime scene that represents the state of shooting in the daytime; and a night view scene that represents the state of shooting of a night view. The scene determination portion 51 extracts, from image data on a noted input image, the amount of image feature that is useful for the scene determination processing, and thus selects the shooting scene of the noted input image from the registration scenes described above, with the result that the shooting scene of the noted input image is determined. The shooting scene determined by the scene determination portion 51 is referred to as a determination scene. The scene determination portion 51 feeds scene determination information indicating the determination scene to the shooting control portion 52 and the display control portion 54.

The shooting control portion 52 sets, based on the scene determination information, a shooting mode specifying shooting conditions. The shooting conditions specified by the shooting mode include: a shutter speed at the time of shooting of the input image (that is, the length of exposure time of the image sensor 33 for obtaining image data on the input image from the image sensor 33); an aperture value at the time of shooting of the input image; an ISO sensitivity at the time of shooting of the input image; and the details of image processing (hereinafter referred to as specific image processing) that is performed by the image processing portion 53 on the input image. The ISO sensitivity refers to the sensitivity specified by ISO (International Organization for Standardization); by adjusting the ISO sensitivity, it is possible to adjust the brightness (brightness level) of the input image. In fact, the amplification factor of the signal in the AFE 12 is determined according to the ISO sensitivity. After the setting of the shooting mode, the shooting control portion 52 controls the image sensing portion 11 and the AFE 12 under the shooting conditions of the set shooting mode so as to obtain the image data on the input image, and also controls the image processing portion 53.

The image processing portion 53 performs the specific image processing on the input image to generate an output image (that is, the input image on which the specific image processing has been performed). No specific image processing may be performed depending on the shooting mode set by the shooting control portion 52; in this case, the output image is the input image itself

For specific description, it is assumed that there are N types of registration scenes (N is an integer equal to or greater than two). In other words, the number of the registration scenes described above is assumed to be N. The N types of registration scenes are called the first to the N-th registration scenes. When an arbitrary integer i and an arbitrary integer j are present, the i-th registration scene and the j-th registration scene differ from each other (where i≦N, j≦N and i≠j). When the determination scene determined by the scene determination portion 51 is the i-th registration scene, the shooting mode set by the shooting control portion 52 is called the i-th shooting mode.

With respect to the first to the N-th shooting modes, shooting conditions specified by the i-th shooting mode and shooting conditions specified by the j-th shooting mode differ from each other. This generally holds true for an arbitrary integer i and an arbitrary integer j that differ from each other (where i≦N and j≦N) but the shooting conditions of N_{A} shooting modes included in the first to the N-th shooting modes can be the same as each other (in other words, the N_{A} shooting modes can the same as each other). N_{A} is an integer less than N but equal to or greater than 2. For example, when N=10, the shooting conditions of the first to the ninth shooting modes differ from each other but the shooting conditions of the ninth and the tenth shooting modes can be the same as each other (in this case, N_{A}=2).

In the following description, it is assumed that the first to the fourth registration scenes included in the first to the N-th registration scenes are respectively the portrait scene, the scenery scene, the leaf coloration scene and the animal scene, that the first to the fourth shooting modes corresponding to the first to the fourth registration scenes are respectively the portrait mode, the scenery mode, the leaf coloration mode and the animal mode and that, within the first to the fourth shooting modes, shooting conditions of two arbitrary shooting modes differ from each other.

Specifically, for example, the shooting control portion 52 varies an aperture value between the portrait mode and the scenery mode, and thus makes the depth of field in the portrait mode narrower than that in the scenery mode. An image 210 of FIG. 5A represents an output image (or an input image) obtained in the scenery mode; an image 220 of FIG. 5B represents an output image (or an input image) obtained in the portrait mode. The output images 210 and 220 are obtained by shooting the same subject. However, based on a difference between the depths of field, the person and the scenery appear clear in the output image 210 whereas the person appears clear but the scenery appears blurred in the output image 220 (in FIG. 5B, the thick outline of the mountain is used to represent blurring).

Alternatively, the same aperture value may be used in the portrait mode and the scenery mode whereas the specific image processing is varied between the portrait mode and the scenery mode, with the result that the depth of field in the portrait mode may be narrower than that in the scenery mode. Specifically, for example, when the shooting mode that has been set is the scenery mode, the specific image processing performed on the input image does not include background blurring processing whereas, when the shooting mode that has been set is the portrait mode, the specific image processing performed on the input image includes background blurring processing. The background blurring processing refers to processing (such as spatial domain filtering using a Gaussian filter) for blurring an image region other than an image region where image data on a person is present in the input image. The difference between the specific image processing including the background blurring processing and the specific image processing excluding the background blurring processing as described above allows the depth of field to be substantially varied between the output image in the portrait mode and the output image in the scenery mode.

Moreover, for example, when the shooting mode that has been set is the portrait mode, the specific image processing performed on the input image may include skin color correction whereas, when the shooting mode that has been set is the scenery mode, the leaf coloration mode or the animal mode, the specific image processing performed on the input image may not include skin color correction. The skin color correction is processing that corrects the color of a part of the image of a person's face which is classified into skin color.

Moreover, for example, when the shooting mode that has been set is the leaf coloration mode, the specific image processing performed on the input image may include red color correction whereas, when the shooting mode that has been set is the portrait mode, the scenery mode or the animal mode, the specific image processing performed on the input image may not include red color correction. The red color correction is processing that corrects the color of a part which is classified into red color.

For example, in the animal mode, which should also be called a high-speed shutter mode, the shutter speed is set faster (that is, the length of exposure time of the image sensor 33 for obtaining image data on the input image from the image sensor 33 is set shorter than those in the portrait mode, the scenery mode and the leaf coloration mode).

The display control portion 54 of FIG. 3 is a portion that controls the details of a display on the display portion 15; the display control portion 54 generates a display image based on the output image from the image processing portion 53, the scene determination information and determination region information from the scene determination portion 51, and displays the display image on the display screen of the display portion 15. The determination region information is information that indicates the position and size of the determination region; the center position of the determination region, the size of the determination region in the horizontal direction and the size of the determination region in the vertical direction, on an arbitrary two-dimensional image (the input image, the output image or the display image) are determined by the determination region information.

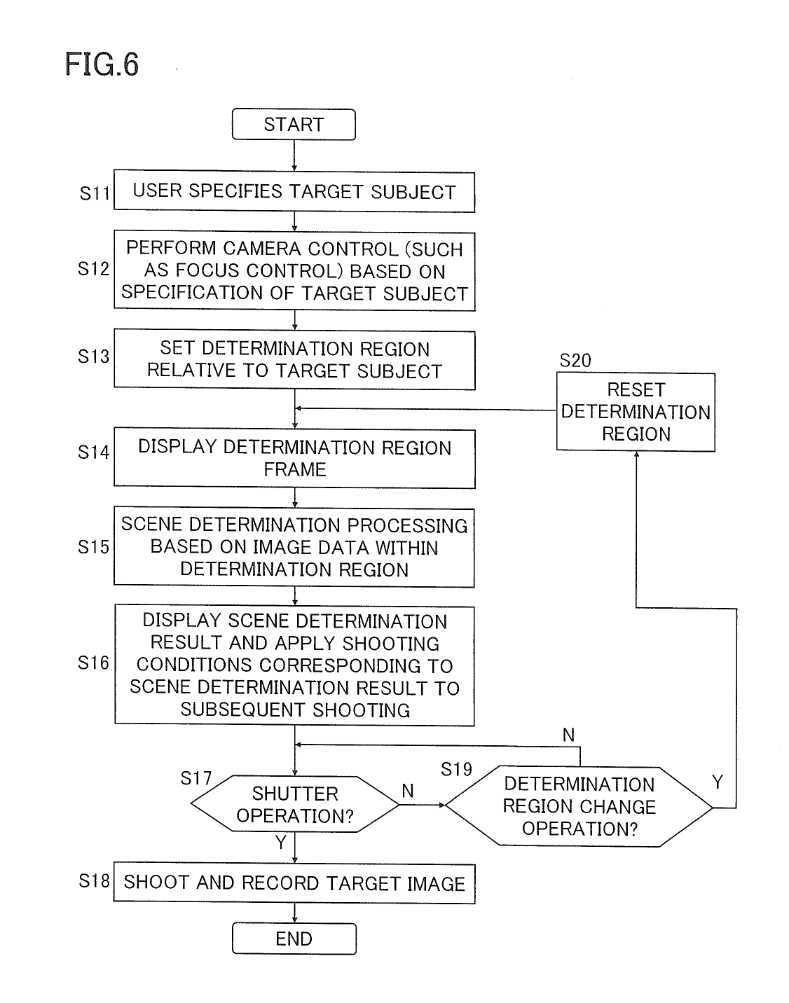

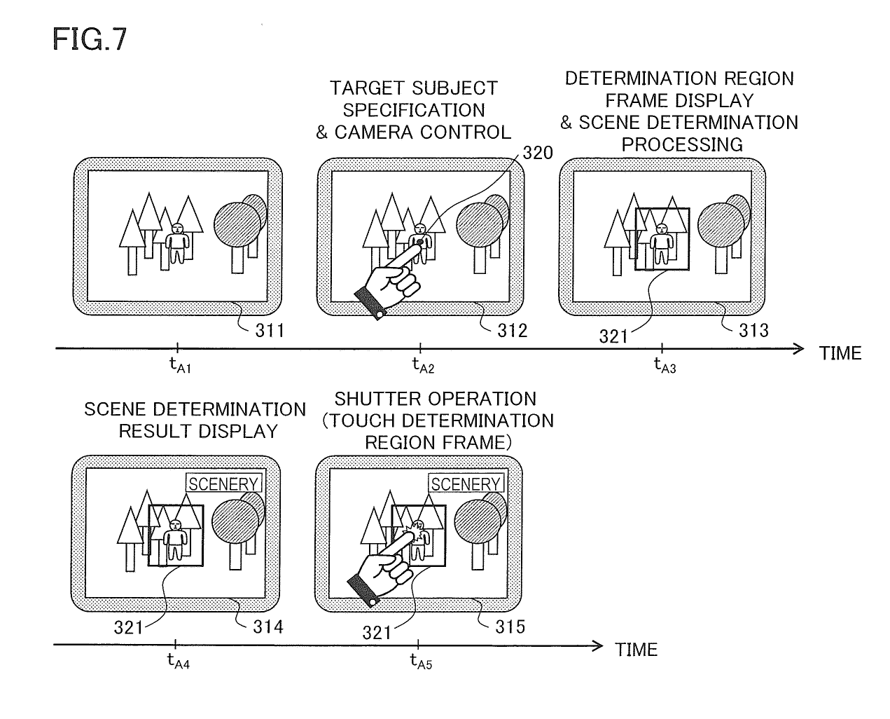

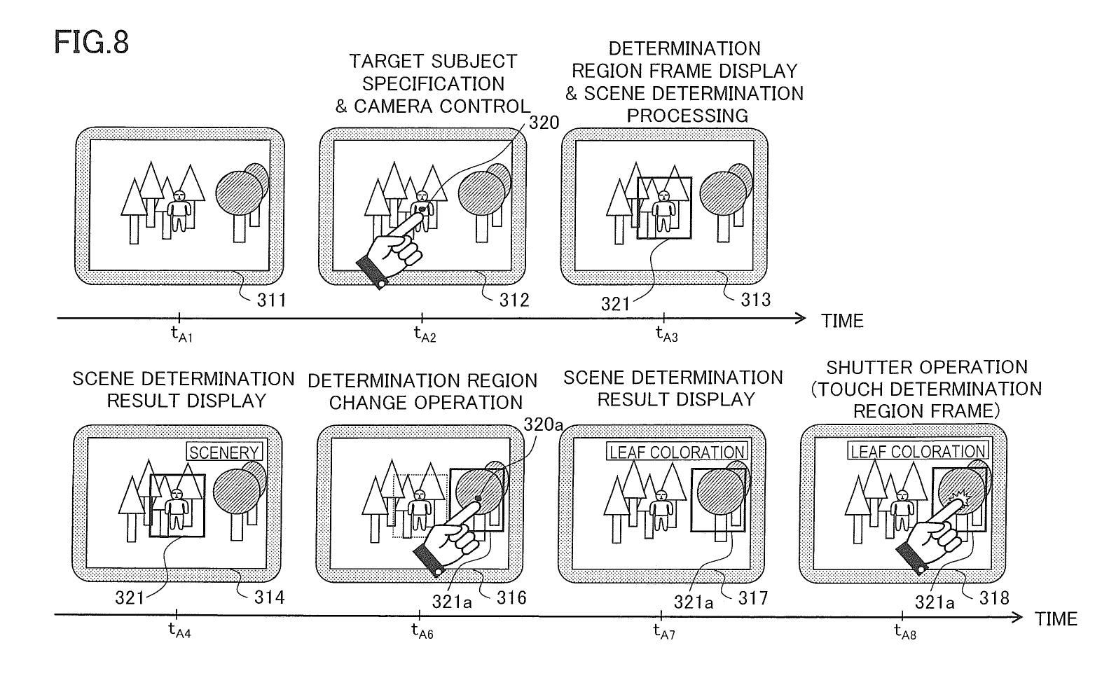

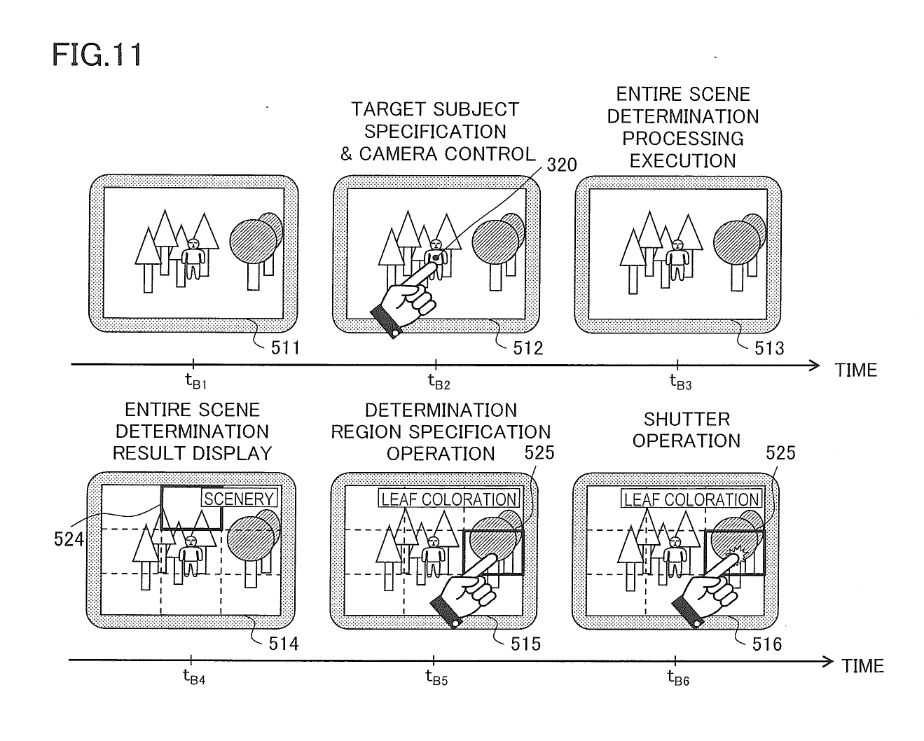

The operations of the portions shown in FIG. 3 will be described in detail with reference to FIGS. 6 and 7. FIG. 6 is a flowchart showing the operation procedure of the image sensing device 1 of the first embodiment. FIG. 7 shows a first specific operation example of the image sensing device 1. In the first specific operation example, trees with yellow leaves located substantially in front of the image sensing device 1 and trees with red leaves located on the right side of the image sensing device 1 are kept in the shooting range, and the user intends to shoot a still image (the same is true in specific operation examples corresponding to FIGS. 8 and 11 described later). A person stands substantially in the middle of the shooting range. In FIG. 7, reference numerals 311 to 315 represent display images at times t_{A1} to t_{A5}, respectively. A time t_{Ai+1} is behind a time t_{Ai} (i is an integer). In FIG. 7, each of dotted regions (regions filled with dots) surrounding the display images 311 to 315 indicates the housing of the display portion 15.

The display image 311 corresponds to a display image before specification in step S11; the display image 312 corresponds to a display image at the time of specification in step S11; the display image 313 corresponds to a display image at the time when processing in steps S13 to S15 is performed; the display image 314 corresponds to a display image at the time when processing in step S16 is performed; and the display image 315 corresponds to a display image at the time when a shutter operation in step S17 is performed. In FIG. 7, the picture of a hand shown in each of the display images 312, 313 and 315 represents a hand of the user.

As described previously, the image sensing portion 11 obtains image data on an input image at a predetermined frame rate. When processing in the steps shown in FIG. 6 is performed, a plurality of input images arranged chronologically are obtained by shooting, and a plurality of display images based on the input images are displayed as a moving image on the display screen. In step S11, while this display is being produced (for example, while the image 311 of FIG. 7 is being displayed), the user specifies a target subject. The user can specify the target subject by performing the touch panel operation. Specifically, a portion of the display screen where the target subject is displayed is touched, and thus it is possible to specify the target subject. The touching refers to an operation of touching a specific portion of the surface of the display screen by a finger. Instead of the touch panel operation, the user can also specify the target subject by performing the button operation.

A point 320 on the display screen is now assumed to be touched (see a portion of the display image 312 in FIG. 7). The coordinate value of the point 320 on the display screen is fed as a specification coordinate value from the touch panel 19 to the scene determination portion 51 and the shooting control portion 52. The specification coordinate value specifies a position (hereinafter referred to as a specification position) corresponding to the point 320 on the input image, the output image and the display image. After the specification in step S11, processing in steps S12 to S17 is performed step by step.

In step S12, the shooting control portion 52 recognizes, as the target subject, a subject present in the specification position, and then performs camera control on the target subject. The camera control performed on the target subject includes focus control in which the target subject is focused and exposure control in which the exposure of the target subject is optimized. When image data on a certain specific subject is present in the specification position, the specific subject is recognized as the target subject, and the camera control is performed.

In step S13, the scene determination portion 51 sets a determination region (specific image region) relative to the specification position in the input image. For example, a determination region is set whose center position is the specification position and which has a predetermined size. For example, by detecting and extracting, from the entire image region of the input image, an image region where the image data on the target subject is present, the extracted image region may be set to the determination region. The determination region information indicating the position and size of the determination region that has been set is fed to the display control portion 54.

At the time when the processing in steps S11 to S13 is performed, the display control portion 54 can display the input image as the display image without the input image being processed. In step S14, the display control portion 54 displays an image obtained by superimposing a determination region frame on the input image, as the display image on the display screen. The determination region frame refers to the outside frame of the determination region. Alternatively, a frame (for example, a frame obtained by slightly reducing or enlarging the outside frame of the determination region) relative to the outside frame of the determination region may be the determination region frame. For example, in step S14, the display image 313 on which a determination region frame 321 is superimposed is displayed (see FIG. 7). The display of the determination region frame allows the user to visually recognize the position and size of the determination region on the input image, the output image, the display image or the display screen. The determination region frame displayed in step S14 thereafter remains displayed in steps S15 to S17.

In step S15, the scene determination portion 51 extracts image data within the determination region in the input image, and performs the scene determination processing based on the extracted image data. The scene determination processing may be performed utilizing not only the image data within the determination region but also focus information, exposure information and the like. The focus information indicates a distance from the image sensing device 1 to the subject that is focused; the exposure information is information on the brightness of the input image. The result of the scene determination processing is also hereinafter referred to as a scene determination result. The scene determination information indicating the scene determination result is fed to the shooting control portion 52 and the display control portion 54.

In step S16, the display control portion 54 displays on the display portion 15 the scene determination result obtained in step S15 (see the display image 314 of FIG. 7). For example, the output image based on the input image, the determination region frame and a determination result indicator corresponding to the scene determination result are displayed at the same time. The determination result indicator is formed with characters (including a symbol and a number), a figure (including an icon) or a combination thereof. In step S16, the shooting control portion 52 applies shooting conditions corresponding to the scene determination result in step S15 to the subsequent shooting. For example, if the determination scene resulting from the scene determination processing in step S15 is the scenery scene, the input images and the output images are thereafter generated under the shooting conditions of the scenery mode until a different scene determination result is obtained.

In step S17, the main control portion 13 checks whether or not a shutter operation is performed, and if the shutter operation is performed, the process proceeds from step S17 to step S18 whereas, if the shutter operation is not performed, the process proceeds from step S17 to step S19. The shutter operation refers to an operation of touching the present position within the determination region on the display screen (see FIG. 7). Another touch panel operation may be allocated to the shutter operation; the shutter operation may be achieved by performing a button operation (for example, an operation of pressing the shutter button 20).

In step S18, to which the process proceeds if the shutter operation is performed, a target image is shot using the image sensing portion 11 and the image processing portion 53. The target image is an output image based on an input image obtained immediately after the shutter operation. Image data on the obtained target image is recorded in the record medium 16.

On the other hand, in step S19, the main control portion 13 checks whether or not a determination region change operation is performed, and if the determination region change operation is not performed, the process returns from step S19 to step S17 whereas, if the determination region change operation is performed, the process proceeds from step S19 to step S20. The determination region change operation is an operation of changing the position of the determination region by the user. The size of the determination region can also be changed by the determination region change operation. The determination region change operation may be achieved either by the touch panel operation or by the button operation. In step S20, the determination region is reset according to the determination region change operation, and, after the resetting, the process returns to step S14, and the processing in step S14 and the subsequent steps is performed again. In other words, the determination region frame in the reset determination region is displayed (step S14), the scene determination processing based on image data within the reset determination region is performed and the result thereof is displayed (steps S15 and S16) and the other processing is performed. A specific detailed example of the processing in steps S19 and S20 will be described later with reference to FIG. 8.

Although part of the above description is repeated, the first specific operation example shown in FIG. 7 will be described according to processing in each step in FIG. 6.

At the time t_{A1}, a target subject is not specified by the user, and an input image shot at the time t_{A1} is displayed as the display image 311. At the time t_{A2}, the user performs the touch panel operation to touch the point 320 (step S11). The display image 312 is an input image that is shot at the time t_{A2}. By touching the point 320, the camera control is performed on the target subject arranged at the point 320, and the determination region is set relative to the point 320 (steps S12 and S13). Consequently, the display image 313 is displayed at the time t_{A3} (step S14). The display image 313 is an image that is obtained by superimposing the determination region frame 321 on the input image obtained at the time t_{A3}.

Thereafter, the scene determination processing is performed on the determination region relative to the point 320 (step S15), and the scene determination result thereof is displayed (step S16). For example, the display image 314 is displayed. In the first specific operation example, the determination scene resulting from the scene determination processing performed relative to the point 320 is assumed to be the scenery scene (the same is true in a second specific operation example corresponding to FIG. 8 and described later). The display image 314 is an image that is obtained by superimposing the determination region frame 321 and a word “scenery” on the input image obtained at the time t_{A4}. The word “scenery” refers to one type of determination result indictor which indicates either that the determination scene resulting from the scene determination processing is the scenery scene or that the shooting mode set based on the scene determination result is the scenery mode. As described previously, the scene determination result is applied to the subsequent shooting (step S16). Hence, if the determination scene resulting from the scene determination processing is the scenery scene, the input images and the output images shot at the time t_{A4} and the subsequent times are generated under the shooting conditions of the scenery mode until a different scene determination result is obtained. Although, for convenience of description, it is assumed that the determination result indicator is not displayed at the time t_{A3} (in other words, the determination result indicator is not displayed on the display image 313), the determination region frame 321 may always be displayed together with the determination result indicator.

In the first specific operation example corresponding to FIG. 7, at the time t_{A5}, the user touches a position within the determination region frame 321 to perform the shutter operation. Thus, immediately after the time t_{A5}, the target image is shot in the scenery mode. The display image 315 is an image that is obtained by superimposing the determination region frame 321 and the word “scenery” on the input image obtained at the time t_{A5}. FIG. 7 shows how a position within the determination region frame 321 is touched at the time t_{A5}.

The second specific operation example different from the first specific operation example shown in FIG. 7 will be described. FIG. 8 shows the second specific operation example of the image sensing device 1. In FIG. 8, reference numerals 311 to 314 respectively represent the same display images at the times t_{A1} to t_{A4} as shown in FIG. 7. In FIG. 8, reference numerals 316 to 318 represent display images at times t_{A6} to t_{A8}, respectively. In FIG. 8, each of dotted regions (regions filled with dots) surrounding the display images 311 to 314 and 316 to 318 indicates the housing of the display portion 15; the picture of a hand shown in each of the display images 312, 313, 316 and 318 represents a hand of the user.

The operations (including the operation at the time t_{A4}) that have been performed until the time t_{A4} in the first specific operation example are the same as in the second specific operation example. However, unlike the first specific operation example, the determination region change operation (see step S19 in FIG. 6) is performed in the second specific operation example. Operations that are performed after the time t_{A4} in the second specific operation example will be described. Although the display image 314 at the time t_{A4} shows that the determination scene and the shooting mode based on the determination scene are the scenery scene and the scenery mode, respectively, it is assumed that the user does not desire to shoot the target image in the scenery mode. In this case, the user does not perform the shutter operation (N in step S17) but performs the determination region change operation. The determination region change operation is an operation of touching, for example, a point 320a on the display screen different from the point 320.

At the time t_{A6} behind the time t_{A4}, the point 320a on the display screen is assumed to be touched. Then, a coordinate value at the point 320a on the display screen is fed as the second specification coordinate value from the touch panel 19 to the scene determination portion 51. The second specification coordinate value specifies a position (hereinafter referred to as a second specification position) corresponding to the point 320a on the input image, the output image and the display image. When the determination region change operation is performed by the specification of the point 320a, in step S20, the scene determination portion 51 resets the determination region relative to the second specification position. For example, a determination region is reset whose center position is the second specification position and which has a predetermined size. Around the time when the determination region is reset, the size of the determination region may remain the same or may change. The determination region information indicating the position and size of the determination region that has been reset is fed to the display control portion 54.

As soon as the determination region change operation is performed, the position on the display screen where the determination region frame is displayed is changed (step S14). In FIG. 8, a rectangular frame 321a indicates the determination region frame that has been changed. The determination region frame 321a refers to the outside frame of the determination region that has been reset. Alternatively, a frame (for example, a frame obtained by slightly reducing or enlarging the outside frame of the determination region that has been reset) relative to the outside frame of the determination region that has been reset may be the determination region frame 321a. The display image 316 is an image that is obtained by superimposing the determination region frame 321a on the input image obtained at the time t_{A6}; FIG. 8 shows how the point 320a on the display screen is touched. The specific method of performing the determination region change operation can freely be changed. For example, the determination region change operation may be achieved by dragging and dropping the determination region frame and thereby giving an instruction to move the center position of the determination region frame from the point 320 to the point 320a.

When the determination region change operation is performed, the scene determination processing in step S15 is performed again. Specifically, image data within the determination region that has been reset is extracted from the latest input image obtained after the determination region change operation, and the scene determination processing is performed again based on the extracted image data (step S15).

The result of the scene determination processing that has been performed again is displayed at the time t_{A7} (step S16). For example, the display image 317 is displayed at the time t_{A7}. In the second specific operation example, the determination scene resulting from the scene determination processing that has been performed relative to the point 320a is assumed to be the leaf coloration scene. The display image 317 is an image that is obtained by superimposing the determination region frame 321a and a word “leaf coloration” on the input image obtained at a time t_{A7}. The word “leaf coloration” refers to one type of determination result indictor which indicates either that the determination scene resulting from the scene determination processing is the leaf coloration scene or that the shooting mode set based on the scene determination result is the leaf coloration mode. As described previously, the scene determination result is applied to the subsequent shooting (step S16). Hence, if the determination scene resulting from the scene determination processing that has been performed again is the leaf coloration scene, the input images and the output images shot at the time t_{A7} and the subsequent times are generated under the shooting conditions of the leaf coloration mode until a different scene determination result is further obtained. Although, for convenience of description, it is assumed that the determination result indicator is not displayed at the time t_{A6}, the determination region frame 321a may always be displayed together with the determination result indicator.

In the second specific operation example corresponding to FIG. 8, the operation of touching the point 320a at the time t_{A6} is cancelled, and thereafter the shutter operation is performed as a result of the user touching a position within the determination region frame 321a again at the time t_{A8}. In this way, the target image is shot in the leaf coloration mode immediately after the time t_{A8}. The display image 318 is an image that is obtained by superimposing the determination region frame 321a and the word “leaf coloration” on the input image obtained at the time t_{A8}. FIG. 8 shows how the position within the determination region frame 321a is touched at the time t_{A8}.

When the operation described above is performed, it is possible to perform the specification of the target subject as part of the operation of shooting the target image, and it is possible to perform the scene determination processing with the target subject focused. When the scene determination result is displayed, the determination region frame indicating the position of the determination region on which the scene determination result is based is displayed simultaneously. This allows the user to intuitively know not only the scene determination result but also the reason why such a result is obtained. When the scene determination result that is temporarily obtained differs from that desired by the user, the user can adjust the position of the determination region so as to obtain the desired scene determination result. This adjustment is easily performed by displaying the position of the determination region on which the scene determination result is based. That is because the display screen allows the user to roughly expect what scene determination result will be obtained when the determination region is moved to a given position. For example, if the user desires the determination of the leaf coloration, it is possible to give an instruction to redetermine the shooting scene by performing an intuitive operation of moving the determination region to a portion where colored leaves are displayed.

When the first scene determination processing is performed, and then the determination region is reset by the determination region change operation, and then the second scene determination processing is performed based on image data on the determination region that has been reset, the second scene determination processing is preferably performed such that the result of the second scene determination processing certainly differs from the result of the first scene determination processing. Since the user performs the determination region change operation in order to obtain a scene determination result different from the first scene determination result, the fact that the first and second scene determination results differ from each other satisfies the user. For example, when the determination scene resulting from the first scene determination processing is the first registration scene, the determination scene is preferably selected from the second to the N-th registration scenes in the second scene determination processing.

### Second Embodiment

A second embodiment of the present invention will be described. Since the overall configuration of an image sensing device of the second embodiment is the same as in FIG. 1, the image sensing device of the second embodiment is also identified with reference numeral 1. The second embodiment is based on the first embodiment; the description in the first embodiment can also be applied to what is not particularly described in the second embodiment unless a contradiction arises.

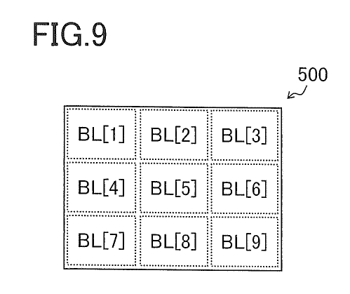

Reference numeral 500 of FIG. 9 represents an arbitrary two-dimensional image or display screen. When reference numeral 500 represents a two-dimensional image, the two-dimensional image 500 is the input image, the output image or the display image described above. When reference numeral 500 represents a two-dimensional image, the two-dimensional image 500 is divided into three equal parts both in horizontal and vertical directions, and thus the entire image region of the two-dimensional image 500 is divided into nine division blocks BL[1] to BL[9] that should be called nine division image regions (in this case, the division blocks BL[1] to BL[9] are the division image regions that differ from each other). Likewise, when reference numeral 500 represents a display screen, the display screen 500 is divided into three equal parts both in horizontal and vertical directions, and thus the entire display region of the display screen 500 is divided into nine division blocks BL[1] to BL[9] that should be called nine division display regions (in this case, the division blocks BL[1] to BL[9] are the division display regions that differ from each other). A division block BL[i] on the input image, a division block BL[i] on the output image and a division block BL[i] on the display image correspond to each other, and an image within the division block BL[i] on the display image is displayed within the division block BL[i] of the display screen. As described previously, i is an integer.

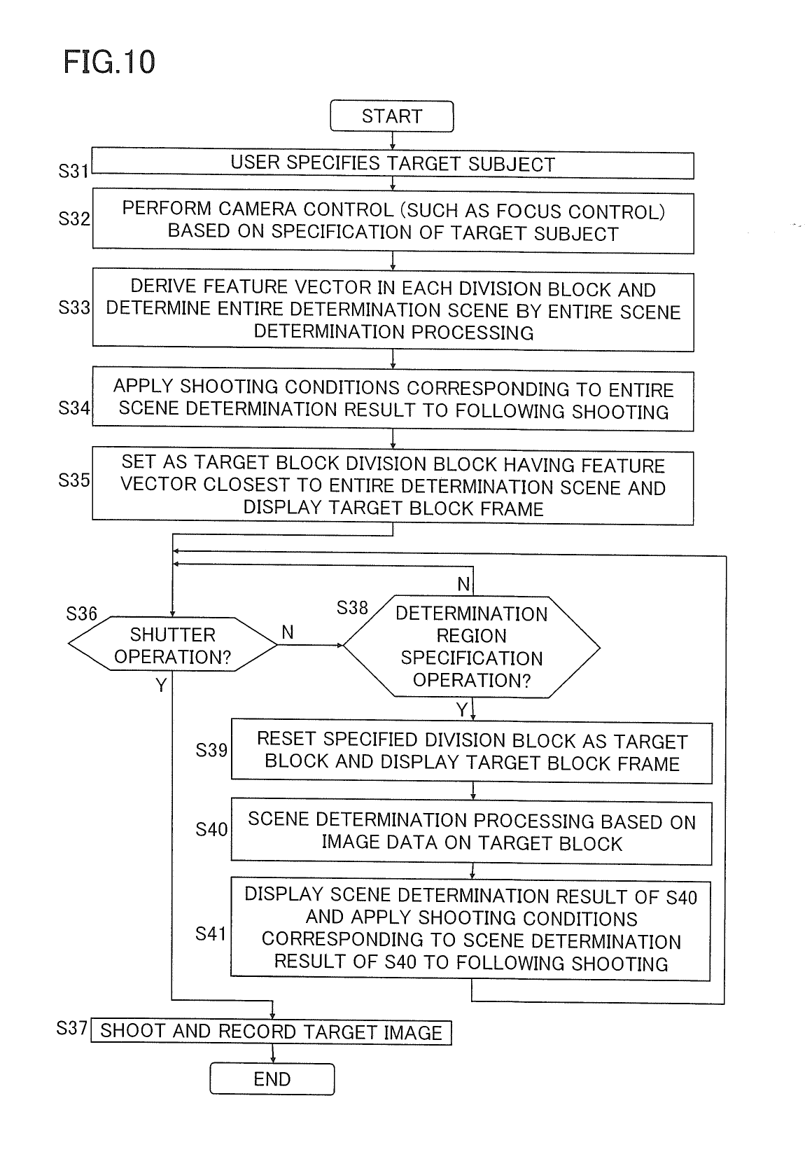

In the image sensing device 1 of the second embodiment, the scene determination portion 51, the shooting control portion 52, the image processing portion 53 and the display control portion 54 shown in FIG. 3 are also provided. The operations of the portions shown in FIG. 3 will be described in detail with reference to FIGS. 10 and 11. FIG. 10 is a flowchart showing the operation procedure of the image sensing device 1 of the second embodiment. FIG. 11 shows a specific operation example of the image sensing device 1 of the second embodiment. In FIG. 11, reference numerals 511 to 516 represent display images at times t_{B1} to t_{B6}, respectively. A time t_{Bi+1} is behind a time t_{Bi}. In FIG. 11, each of dotted regions (regions filled with dots) surrounding the display images 511 to 516 indicates the housing of the display portion 15; the picture of a hand shown in each of the display images 512, 515 and 516 represents a hand of the user.

When processing in the steps shown in FIG. 10 is performed, a plurality of input images arranged chronologically are obtained by shooting, and a plurality of display images based on the input images are displayed as a moving image on the display screen. In step S31, while this display is being produced (for example, while the image 511 of FIG. 11 is being displayed), the user specifies a target subject. A method of specifying the target subject is the same as described in the first embodiment.

In step S31, a point 320 on the display screen is now assumed to be touched (see the display image 512 in FIG. 11). The coordinate value of the point 320 on the display screen is fed as a specification coordinate value from the touch panel 19 to the scene determination portion 51 and the shooting control portion 52. The specification coordinate value specifies a position (specification position) corresponding to the point 320 on the input image, the output image and the display image. After the specification in step S31, processing in steps S32 to S36 is performed step by step. The details of the processing in step S32 are the same as those in step S12 (FIG. 6). Specifically, in step S32, the shooting control portion 52 recognizes, as the target subject, a subject present in the specification position, and then performs the camera control on the target subject.

In step S33, the scene determination portion 51 performs feature vector derivation processing, and thereby derives a feature vector for each of the division blocks of the input image. An image region or a division block from which the feature vector is derived is referred to as a feature evaluation region. The feature vector represents the feature of an image within the feature evaluation region, and is the amount of image feature corresponding to the shape, color and the like of an object in the feature evaluation region. As a method of deriving the feature vector of the image region, an arbitrary method including a known method can be used for the feature vector derivation processing performed by the scene determination portion 51. For example, the scene determination portion 51 can derive the feature vector of the feature evaluation region using a method specified by MPEG (moving picture experts group) 7. The feature vector is a J-dimensional vector that is arranged in a J-dimensional feature space (J is an integer equal to or greater than two).

In step S33, the scene determination portion 51 further performs entire scene determination processing (see the display image 513 in FIG. 11). The entire scene determination processing refers to scene determination processing that is performed after the entire image region of the input image is set at the determination region, and the entire scene determination processing is performed based on image data on the entire image region of the input image. The shooting scene of the entire input image is determined by the entire scene determination processing. The entire scene determination processing in step S33 may be performed utilizing not only the image data on the entire image region of the input image but also the focus information, the exposure information and the like. The shooting scene of the entire input image determined by the entire scene determination processing is referred to as the entire determination scene.

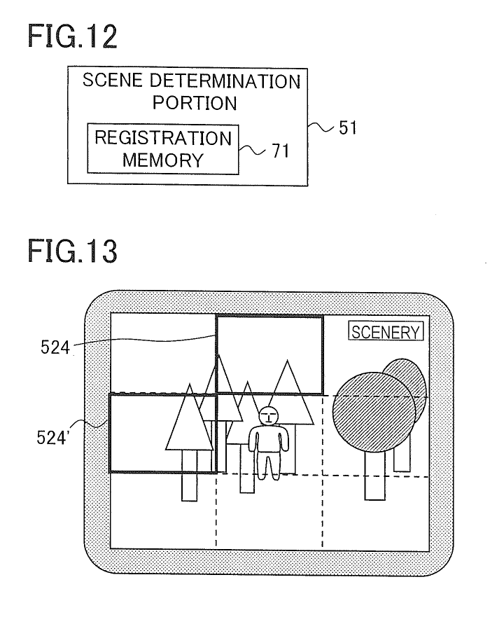

Incidentally, as described in the first embodiment, the determination scene (including the entire determination scene) is selected from N registration scenes, and is thus determined; for each of the registration scenes, a feature vector corresponding to the registration scene is previously set. A feature vector corresponding to a certain registration scene is the amount of image feature that indicates the feature of an image corresponding to the registration scene. A feature vector that is set for each of the registration scenes is particularly referred to as a registration vector; a registration vector for the i-th registration scene is represented by VR[i]. The registration vectors of the individual registration scenes are stored in a registration memory 71, shown in FIG. 12, within the scene determination portion 51 (the same is also true in the first embodiment).

In the entire scene determination processing in step S33, for example, the entire image region of the input image is regarded as the feature evaluation region, then the feature vector derivation processing is performed, thus a feature vector V_{W} for the entire image region of the input image is derived and a registration vector closest to the feature vector V_{W} is detected and thus the entire determination scene is determined.

Specifically, a distance d_{W}[i] between the feature vector V_{W} and the registration vector VR[i] is first determined. A distance between an arbitrary first feature vector and an arbitrary second feature vector is defined as a distance (Euclidean distance) between the endpoints of first and second feature vectors in the feature space when the starting points of the first and second feature vectors are arranged at the original point of the feature space. A computation for determining the distance d_{W}[i] is individually performed by substituting, into i, each of integers equal to or greater than one but equal to or less than N. Thus, the distances d_{W}[1] to d_{W}[N] are determined. Then, the registration scene corresponding to the shortest of the distances d_{W}[1] to d_{W}[N] is preferably set at the entire determination scene. For example, when the distance d_{W}[2] corresponding to the second registration scene is the shortest of the distances d_{W}[1] to d_{W}[N], the registration vector VR[2] is the registration vector that is the closest to the feature vector V_{W}, and the second registration scene (for example, the scenery scene) is determined as the entire determination scene.

The result of the entire scene determination processing is also hereinafter referred to as an entire scene determination result. The entire scene determination result in step S33 is included in the scene determination information, and it is transmitted to the shooting control portion 52 and the display control portion 54.

In step S34, the shooting control portion 52 applies shooting conditions corresponding to the entire scene determination result to the subsequent shooting. For example, if the entire determination scene resulting from the entire scene determination processing in step S33 is the scenery scene, the input images and the output images are thereafter generated under the shooting conditions of the scenery mode until a different scene determination result (including a different entire scene determination result) is obtained.

In step S35 subsequent to the above step, the display control portion 54 displays on the display portion 15 the result of the entire scene determination processing in step S33. In step S35, the scene determination portion 51 sets a division block having a feature vector closest to the entire determination scene at a target block (specific image region), and transmits to the display control portion 54 which of the division blocks is the target block. Hence, in step S35, the display control portion 54 also displays a target block frame on the display portion 15. In other words, in step S35, the output image based on the input image, the target block frame corresponding to the target block and the determination result indicator corresponding to the entire scene determination result are displayed at the same time (see a display image 514 in FIG. 11). Furthermore, preferably, as with the display image 514, a boundary line between the adjacent division blocks is additionally displayed (the same is also true in display images 515 and 516).

The target block frame refers to the outside frame of the target block. Alternatively, a frame (for example, a frame obtained by slightly reducing or enlarging the outside frame of the target block) relative to the outside frame of the target block may be the target block frame. For example, when the target block is the division block BL[2] and the entire determination scene is the scenery scene, in step S35, the display image 514 of FIG. 11 is displayed. The display image 514 is an image that is obtained by superimposing a target block frame 524 surrounding a target block BL[2] and a word “scenery” on the input image obtained at a time t_{B4}. The word “scenery” in the display image 514 refers to one type of determination result indictor which indicates either that the entire determination scene is the scenery scene or that the shooting mode set in step S34 based on the entire scene determination result is the scenery mode.

The method of setting the target block in step S35 will be additionally described. The feature vector of the division block BL[i] calculated in step S33 is represented by V_{Di}. For specific description, the entire determination scene is assumed to be the second registration scene. In this case, the scene determination portion 51 determines a distance ddᵢ between the registration vector VR[2] corresponding to the entire determination scene and the feature vector V_{Di} . A computation for determining the distance ddᵢ is individually performed by substituting, into i, each of integers equal to or greater than one but equal to or less than 9. Thus, the distances dd₁ to dd₉ are determined. Preferably, the division block corresponding to the shortest of the distances dd₁ to dd₉ is determined to have a feature vector closest to the entire determination scene, and thus the target block is set. For example, if the distance dd₂ is the shortest of the distances dd₁ to dd₉, the division block BL[2] is set at the target block.

The feature vector V_{Di} of the target block set in step S35 largely contributes to the result of the entire scene determination processing in step S33, and image data on the target block (in other words, the feature vector V_{Di} of the target block) is responsible for (main factor) the result of the entire scene determination processing. The display of the target block frame allows the user to visually recognize the position and size of the target block on the input image, the output image, the display image or the display screen. The target block frame displayed in step S35 remains displayed until a shutter operation or a determination region specification operation described later is performed.

In step S35, a plurality of target block frames corresponding to a plurality of target blocks may be displayed by setting a plurality of division blocks at the target blocks. For example, by comparing each of the distances ddᵢ to dd₉ with a predetermined reference distance d_{TH}, all division blocks corresponding to distances equal to or less than the reference distance d_{TH} may be set at the target blocks. For example, if the distances dd₂ to dd₄ are equal to or less than the reference distance d_{TH}, by setting the division blocks BL[2] and BL[4] corresponding to the distances dd₂ to dd₄ at the target blocks, two target block frames 524 and 524′ corresponding to the two target blocks may be displayed as shown in FIG. 13.

In step S36 subsequent to step S35, the main control portion 13 checks whether or not the shutter operation is performed, and if the shutter operation is performed, the process proceeds from step S36 to step S37 whereas, if the shutter operation is not performed, the process proceeds from step S36 to step S38. The shutter operation in step S36 refers to an operation of touching the present position within the target block frame on the display screen. Another touch panel operation may be allocated to the shutter operation; the shutter operation may be achieved by performing a button operation (for example, an operation of pressing the shutter button 20).

In step S37, to which the process proceeds if the shutter operation is performed, a target image is shot using the image sensing portion 11 and the image processing portion 53. The target image is an output image based on an input image obtained immediately after the shutter operation. Image data on the obtained target image is recorded in the record medium 16.

In step S38, the main control portion 13 checks whether or not the determination region specification operation is performed, and if the determination region specification operation is not performed, the process returns from step S38 to step S36. On the other hand, if the determination region specification operation is performed, the process proceeds from step S38 to step S39, and processing in steps S39 to S41 is performed step by step, and then the process returns to step S36. The determination region specification operation is an operation of specifying the determination region by the user; it may be achieved either by the touch panel operation or by the button operation. In the determination region specification operation, the user selects one of the division blocks BL[1] to BL[9]. In step S39, the selected division block is reset at the target block, and a target block frame corresponding to the reset target block is displayed (see the display image 515 in FIG. 11).

In step S40 subsequent to step S39, the scene determination portion 51 performs the scene determination processing based on image data within the target block reset in step S39. The scene determination processing in step S40 may be performed utilizing not only the image data within the reset target block but also the focus information, the exposure information and the like. Then, in step S41, the display control portion 54 displays the scene determination result in step S40 on the display portion 15 (see the display image 515 in FIG. 11). In step S41, the shooting control portion 52 applies shooting conditions corresponding to the scene determination result in step S40 to the subsequent shooting. For example, if the determination scene resulting from the scene determination processing in step S40 is the leaf coloration scene, the input images and the output images are thereafter generated under the shooting conditions of the leaf coloration mode until a different scene determination result is obtained.

In step S41, for example, the output image based on the input image, the reset target block frame and the determination result indicator corresponding to the scene determination result in step S40 are displayed at the same time. If the reset target block is the target block BL[6] and the determination scene obtained from the scene determination result in step S40 is the leaf coloration scene, the display image 515 of FIG. 11 is displayed in step S41. The display image 515 is an image that is obtained by superimposing the target block frame 525 surrounding the target block BL[6] and a word “leaf coloration” on the input image obtained at the time t_{B5}. The word “leaf coloration” in the display image 515 refers to one type of determination result indictor which indicates either that the determination scene obtained from the scene determination result in step S40 is the leaf coloration scene or that the shooting mode set in step S41 based on the scene determination result in step S40 is the leaf coloration mode.

Although part of the above description is repeated, a specific operation example shown in FIG. 11 will be described according to processing in each step in FIG. 10.

At the time t_{B1}, a target subject is not specified by the user, and an input image shot at the time t_{B1} is displayed as the display image 511. At the time t_{B2}, the user performs the touch panel operation to touch the point 320 (step S31). The display image 512 is an input image that is shot at the time t_{B2}. By touching the point 320, the camera control is performed on the target subject arranged at the point 320 (step S32). Thereafter, at the time t_{B3}, the entire scene determination processing is performed (step S33), and shooting conditions corresponding to the entire scene determination result are applied (step S34) whereas at the time t_{B4}, the entire scene determination result is displayed (step S35). In other words, the display image 514 is displayed.

With the display image 514 displayed, if the user touches a position within the target block frame 524, the target image is shot and recorded in the scenery mode (steps S36 and S37). Here, it is assumed that the user touches the division block BL[6] on the display screen between the time t_{B4} and the time t_{B5} to perform the determination region specification operation (step S38). In this case, the target block is changed to the division block BL[6], and the target block frame 525 surrounding the division block BL[6] is displayed instead of the target block frame 524 (step S39). Then, the scene determination portion 51 sets the division block BL[6] of the input image that is shot when the determination region specification operation is performed, at the determination region, and performs the scene determination processing based on the image data within the determination region (step S40). The determination scene resulting from this scene determination processing is assumed to be the leaf coloration scene. Then, the display image 515 of FIG. 11 is displayed (step S41).

The touching operation for the determination region specification operation is cancelled, and thereafter, at the time t_{B6}, the user touches again a position within the target block frame 525 on the display screen, and thus the shutter operation is performed. In this way, the target image is shot in the leaf coloration mode immediately after the time t_{B6}.

In the operation described above, when the scene determination result (including the entire scene determination result) is displayed, the target block frame indicating the position of the image region on which the scene determination result is based is displayed simultaneously. This allows the user to intuitively know not only the scene determination result but also the reason why such a result is obtained. When the scene determination result that is temporarily obtained differs from that desired by the user, the user can adjust the position of the image region on which the scene determination result is based so as to obtain the desired scene determination result. This adjustment is easily performed by displaying the position of the image region on which the scene determination result is based. That is because the display screen allows the user to roughly expect what scene determination result will be obtained when a certain image region is specified as the determination region that is the target block. For example, if the user desires the determination of the leaf coloration, it is possible to give an instruction to redetermine the shooting scene by performing an intuitive operation of specifying a portion where colored leaves are displayed as the target block (determination region).

When the entire scene determination processing in step S33 is performed, and then the determination region specification operation is performed, the scene determination processing in step S40 is performed. Preferably, the scene determination processing in step S40 is performed such that the result of the scene determination processing in step S40 certainly differs from the result of the entire scene determination processing. Since the user performs the determination region specification operation in order to obtain a scene determination result different from the entire scene determination result, the fact that they differ from each other satisfies the user. Simply, for example, if the determination scene resulting from the entire scene determination processing is the first registration scene, the determination scene is preferably selected from the second to the N-th registration scenes in the scene determination processing in step S40.

Alternatively, it is possible to employ the following method. It is now assumed that, as in the specific operation example of FIG. 11, the entire determination scene resulting from the entire scene determination processing is the scenery scene, the target block set in step S35 is the division block BL[2], and the target block reset by the determination region specification operation is the division block BL[6]. In this case, in step S40, the scene determination portion 51 sets the division block BL[6] of the input image that is shot when the determination region specification operation is performed, at the determination region. Then, the scene determination portion 51 performs the feature vector derivation processing based on image data within the determination region to derive a feature vector V_{A} from the determination region, and performs the scene determination processing using the feature vector V_{A}.

It is assumed that, as described in the first embodiment, the first to the fourth registration scenes included in the first to the N-th registration scenes are respectively the portrait scene, the scenery scene, the leaf coloration scene and the animal scene. The scene determination portion 51 determines a distance d_{A}[i] between the feature vector V_{A} and the registration vector VR[i]. A computation for determining the distance d_{A}[i] is individually performed by substituting, into i, each of integers equal to or greater than one but equal to or less than N. Thus, the distances d_{A}[1] to d_{A}[N] are determined.

If the registration vector closest to the feature vector V_{A} among registration vectors VR[1] to VR[N] is a registration vector VR[3] corresponding to the leaf coloration scene, that is, if a distance d_{A}[3] is the smallest of the distances d_{A}[1] to d_{A}[N], in step S40, the leaf coloration scene, which is the third registration scene, is simply and preferably set at the determination scene.

On the other hand, if the distance d_{A}[2] corresponding to the scenery scene is the smallest of the distances d_{A}[1] to d_{A}[N], the registration scene corresponding to the second smallest distance among the distances d_{A}[1] to d_{A}[N] is set at the determination scene in step S40. In other words, for example, if, among the distances d_{A}[1] to d_{A}[N], the distance d_{A}[2] is the smallest distance, and the distance d_{A}[3] is the second smallest distance, in step S40, the leaf coloration scene, which is the third registration scene, is preferably set at the determination scene.

The same is true when the determination region specification operation is thereafter and further performed (that is, when the second determination region specification operation is performed). In other words, although, when the second determination region specification operation is performed, the second scene determination processing is performed in step S40, the second scene determination processing is preferably performed such that the result of the second scene determination processing certainly differs from the result of the entire scene determination processing and the result of the first scene determination processing in step S40.

<Variation of the Flowchart>

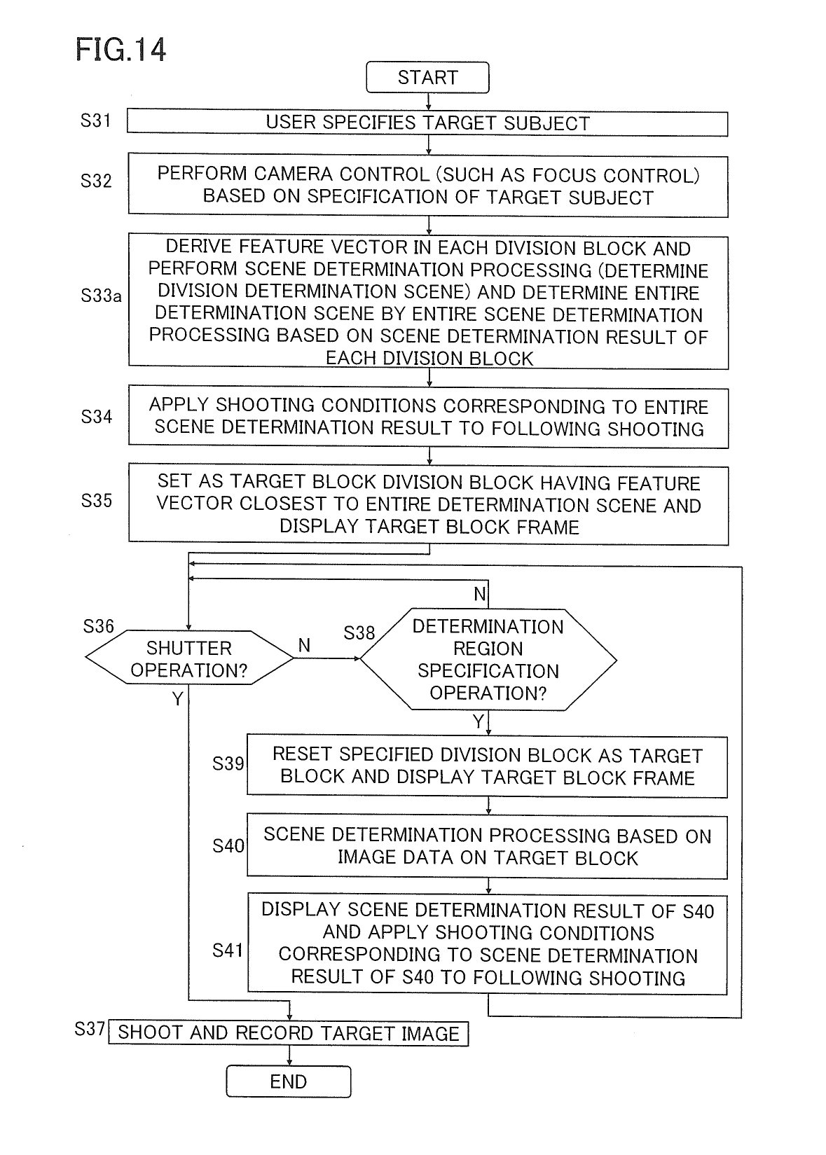

The processing in step S33 in FIG. 10 may be replaced by processing in step S33a. In other words, the flowchart of FIG. 10 may be varied as shown in FIG. 14. Step S33 in the flowchart of FIG. 10 is replaced by step S33a, and thus the flowchart shown in FIG. 14 is formed. In the operation of FIG. 14, after the processing in step S32, the processing in step 33a is performed. The details of the processing in step S33a will be described.

In step S33a, the scene determination portion 51 performs the feature vector derivation processing on each of the division blocks of the input image and thereby derives a feature vector for each of the division blocks, and uses the derived feature vector to perform the scene determination processing on each of the division blocks of the input image. In other words, each of the nine division blocks set in the input image is regarded as the determination region, and, on each of the division blocks, the shooting scene of an image within the division block is determined based on image data within the division block. The scene determination processing may be performed on each of the division blocks utilizing not only the image data within the division block but also the focus information, the exposure information and the like. The determination scene for each of the division blocks is referred to as a division determination scene; a division determination scene for the division block BL[i] is represented by S_{D}[i].

Furthermore, in step S33a, the scene determination portion 51 performs the entire scene determination processing based on the scene determination result of each of the division blocks, and thereby determines the shooting scene of the entire input image. The shooting scene of the entire input image determined in step S33a is also referred to as the entire determination scene.

Simply, for example, in the entire scene determination processing in step S33a, the most frequent division determination scene among the division determination scenes S_{D}[1] to S_{D}[9] can be determined as the entire determination scene. In this case, if the division determination scenes S_{D}[1] to S_{D}[9] are composed of six scenery scenes and three leaf coloration scenes, the entire determination scene is determined to be the scenery scene whereas if the division determination scenes S_{D}[1] to S_{D}[9] are composed of three scenery scenes and six leaf coloration scenes, the entire determination scene is determined to be the leaf coloration scene.

The method of determining the entire determination scene may be advanced using the above frequency and the feature vector of each of the division blocks. For example, if the determination scene of the division blocks BL[1] to BL[3] is the leaf coloration scene, the determination scene of the division blocks BL[4] to BL[9] is the scenery scene, a distance between each of the feature vectors of the division blocks BL[1] to BL[3] and the registration vector VR[3] of the leaf coloration scene is significantly short and a distance between each of the feature vectors of the division blocks BL[4] to BL[9] and the registration vector VR[2] of the scenery scene is relatively long, the shooting scene is probably the leaf coloration scene in terms of the entire input image. Hence, in this case, the entire determination scene may be determined to be the leaf coloration scene. After the processing in step S33a, the processing in step S34 and the subsequent steps is performed.

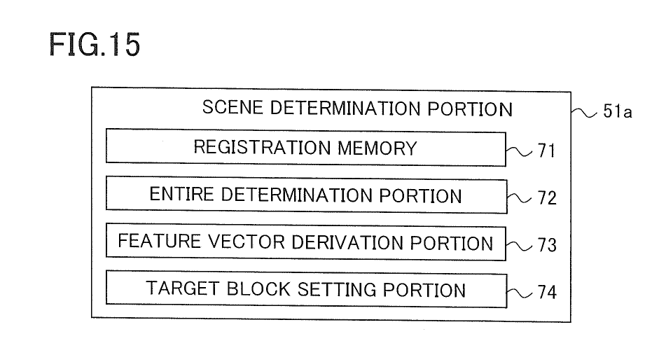

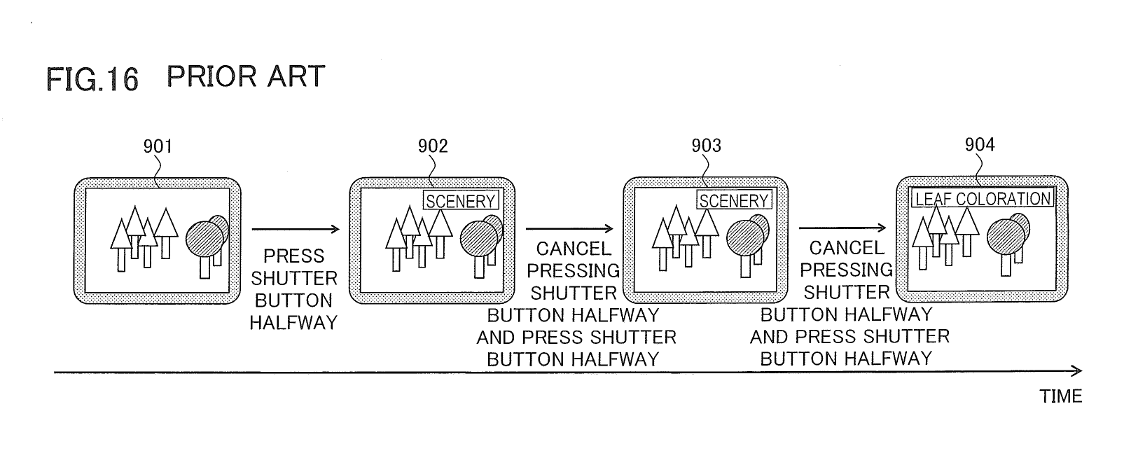

A scene determination portion 51a that can be utilized as the scene determination portion 51 of the second embodiment can be assumed to have a configuration shown in FIG. 15. The scene determination portion 51a includes: the registration memory 71 described previously; an entire determination portion 72 that determines the entire determination scene by performing the entire scene determination processing in step S33 or S33a based on image data on the entire image region of the input image; a feature vector derivation portion (feature amount extraction portion) 73 that derives an arbitrary feature vector by performing the feature vector derivation processing described previously; and a target block setting portion (specific image region setting portion) 74 that sets any of the division blocks at the target block (specific image region).

### Third Embodiment

A third embodiment of the present invention will be described. The description in the first and second embodiments can also be applied to the third embodiment unless a contradiction arises. The above method using the distance between the feature vectors can also be applied to the first embodiment. Specifically, for example, in the second specific operation example (see FIG. 8) of the first embodiment, it is possible to perform processing as follows.

In the second specific operation example of FIG. 8, as a result of the scene determination processing in step S15 that is performed on the determination region relative to the point 320, the determination scene is determined to be the scenery scene (see FIG. 6). Thereafter, when, at the time t_{A6}, the determination region change operation is performed by touching the point 320a on the display screen, the determination region is reset relative to the point 320a. For convenience, the determination region that has been reset is referred to as a determination region 321a′. The scene determination portion 51 regards, as the feature evaluation region, the determination region 321a′ of the latest input image obtained after the determination region change operation, and performs, based on image data within the determination region 321a′ of the latest input image, the feature vector derivation processing on the determination region 321a′ to derive a feature vector V_{B} from the determination region 321a′.

It is assumed that, as described in the first embodiment, the first to the fourth registration scenes included in the first to the N-th registration scenes are respectively the portrait scene, the scenery scene, the leaf coloration scene and the animal scene. The scene determination portion 51 determines a distance d_{B}[i] between the feature vector V_{B} and the registration vector VR[i]. A computation for determining the distance d_{B}[i] is individually performed by substituting, into i, each of integers equal to or greater than one but equal to or less than N. Thus, the distances d_{B}[1] to d_{B}[N] are determined.

If the registration vector closest to the feature vector V_{B} among registration vectors VR[1] to VR[N] is a registration vector VR[3] corresponding to the leaf coloration scene, that is, if the distance d_{B}[3] is the smallest of the distances d_{B}[1] to d_{B}[N], in the second scene determination processing in step S15, the leaf coloration scene, which is the third registration scene, is simply and preferably set at the determination scene.

On the other hand, if the distance d_{B}[2] corresponding to the scenery scene is the smallest of the distances d_{B}[1] to d_{B}[N], the registration scene corresponding to the second smallest distance among the distances d_{B}[1] to d_{B}[N] is set at the determination scene resulting from the second scene determination processing in step S15. In other words, for example, if, among the distances d_{B}[1] to d_{B}[N], the distance d_{B}[2] is the smallest distance and the distance d_{B}[3] is the second smallest distance, in the second scene determination processing in step S15, the leaf coloration scene, which is the third registration scene, is set at the determination scene.

The same is true when the determination region change operation is thereafter and further performed (that is, when the third determination region change operation is performed). In other words, although, when the third determination region change operation is performed, the third scene determination processing is performed in step S15, the third scene determination processing is preferably performed such that the result of the third scene determination processing certainly differs from the results of the first and second scene determination processing in step S15.

<<Variations and the Like>>

Specific values indicated in the above description are simply illustrative; they can be naturally changed to various values. As explanatory notes that can be applied to the above embodiments, explanatory notes 1 and 2 will be described below. The details of the explanatory notes can be freely combined unless a contradiction arises.

[Explanatory Note 1]

Although, in the above description, the number of division blocks that are set in a two-dimensional image or display screen is nine (see FIG. 9), the number thereof may be a number other than nine.

[Explanatory Note 2]

The image sensing device 1 of FIG. 1 can be formed with hardware or a combination of hardware and software. When the image sensing device 1 is formed with software, a block diagram of portions that are provided by software indicates a functional block diagram of those portions. By writing as a program a function achieved with software and performing the program on a program execution device (for example, computer), the function may be achieved.

What is claimed is:

1. An image sensing device comprising:
a display portion that displays a shooting image;
a scene determination portion that determines a shooting scene of the shooting image based on image data on the shooting image; and
a display control portion that displays, on the display portion, a result of determination by the scene determination portion and a position of a specific image region which is a part of an entire image region of the shooting image and on which the result of the determination by the scene determination portion is based.

2. The image sensing device of claim 1, further comprising:
a specification reception portion that receives an input of a specification position on the shooting image,
wherein the scene determination portion sets the specific image region based on the specification position and determines the shooting scene of the shooting image based on image data on the specific image region.

3. The image sensing device of claim 2,
wherein, when the specific image region is set based on a first specification position that is the specification position, and the shooting scene of the shooting image is determined based on the image data on the specific image region, and thereafter a second specification position different from the first specification position is input to the specification reception portion,
the scene determination portion resets the specific image region based on the second specification position and redetermines the shooting scene of the shooting image based on image data on the reset specific image region.

4. The image sensing device of claim 1,
wherein the scene determination portion includes:
an entire determination portion that determines, based on image data on the entire image region of the shooting image, a shooting scene of the entire shooting image as an entire determination scene;
a feature amount extraction portion that divides the entire image region of the shooting image into a plurality of division image regions and that extracts an amount of image feature from image data on each of the division image regions; and
a specific image region setting portion that compares an amount of image feature corresponding to the entire determination scene with the amount of image feature of each of the division image regions so as to select the specific image region from the division image regions and to set the specific image region, and
a display control portion displays, on the display portion, the entire determination scene as the result of the determination by the scene determination portion, and displays, on the display portion, a position of the division image region that is set at the specific image region.

5. The image sensing device of claim 4, further comprising:
a specification reception portion that receives an input of a specification position on the shooting image,
wherein, when the entire determination scene is displayed on the display portion, and then the specification position is input, the scene determination portion resets the specific image region based on the specification position and redetermines the shooting scene of the shooting image based on image data on the reset specific image region.
